(19) United States
(12) Patent Application Publication
(10) Pub. No.: US 2012/0150675 A1
(43) Pub. Date: Jun. 14, 2012

(54) SYSTEM FOR THE COMMERCIALIZATION OF ELECTRONIC CANDLE ILLUMINATION

(76) Inventor: Gabor Lederer, Clifton, NJ (US)

(21) Appl. No.: 13/296,206

(22) Filed: Nov. 14, 2011

Related U.S. Application Data
(63) Continuation-in-part of application No. 11/254,428, filed on Oct. 20, 2005, now abandoned.
Application No. 11/254,428 is a continuation-in-part of application No. 10/666,731, filed on Sep. 19, 2003, now Pat. No. 7,011,426.
(60) Provisional application No. 60/453,611, filed on Mar. 11, 2003.

(51) Int. Cl. G06Q 30/06

(52) U.S. Cl. 705/26.1

(57) ABSTRACT

A system provides for the commercialization of electronic candles in institutions, such as churches or memorial locations wherein a prescribed payment for a predetermined illumination period is verified or validated and an electronic signal then actuates at least one of the electronic candles. The user selects the desired candle for illumination and touches the selected candle for illumination for the prescribed period. A payment account statement is periodically transmitted to the institution or manufacturer to confirm actual payments with the electronic statement of payments to control pilferage. Lighting data and related income is collected and generated for planning purposes. The system is operable locally or remotely with remote viewing capability.

### PRIOR RELATED APPLICATIONS

This application is a continuation-in-part of U.S. Ser. No. 11/254,428, filed Oct. 20, 2005 which is a continuation-in-part of U.S. Ser. No. 10/666,731, filed Sep. 19, 2003, which claims priority to provisional application Ser. No. 60/453,611, filed Mar. 11, 2003, which applications are incorporated herein in their entireties by reference thereto.

### BACKGROUND OF THE INVENTION

1. Field of Use

This invention relates to electronic candles. This invention also specifically relates to a system and method for the commercialization of electronic candle illuminations. This invention also relates to the commercialization of electronic candles wherein payments are made for lighting the candles for a certain period of time.

2. Discussion of the Background and Prior Art

Traditionally, wax candles, such as votive candles and tapers, have been used for memorialization and devotional purposes. Religious institutions generally provide for the purchase and lighting of the wax candles. Purchasers of the candles would make a donation of a desired or recommended amount, which amount is usually deposited in a collection box in order to acquire and light the wax candle.

Wax candles produce pollutants and soot, are a fire hazard. Insurance is costly where wax candles are in general use. The candle art turned to electronic candles, in which the user would touch or turn-on a candle that would then illuminate. Examples of electronic candles are disclosed in U.S. Pat. No. 6,066,924, U.S. Pat. No. 6,017,139, U.S. Pat. No. 5,863,108, U.S. Pat. No. 4,617,614 and U.S. Publication Application 2004/0179355 to Gabor Lederer, the inventor of the present invention. U.S. Patent Publication No. 2002/001373 to Shin et al. discloses an e-commerce method for authorizing the lighting of and paying for a wax candle at a remote location. The wax candle is lit and extinguished by one other then the user-purchaser. The user-purchaser is then expected to visit the burning candle at the remote location. This prior art method was abstruse and designed expressly for remote and candle illumination

The art directed to user-purchaser illumination provides the improvement of placing a motion sensor in the collection box. The motion sensor senses any object deposited into the collection box. A user by merely inserting a coin, bill, or piece of paper or any object by the user in the collection box effect actuation of an electronic candle for illumination. This prior art arrangement is shown in FIG. 1. This prior art method did not adequately control the payment for the illumination, and was unsatisfactory as a practical business means to both the religious institution and the electronic candle manufacturer. The art desired a method for the realistic commercialization of the illumination of electronic candles. In the prior art, in general, activation of a candle for illumination has required the direct presence of either the user-purchaser or a representative person to effect a requisite payment and/or to light a selected candle once payment has been made.

It is therefore a principal object of the present invention to provide a system and method for the commercialization of illuminations of electronic candles.

It is another object of the present invention to provide an improved electronic candle for the aforesaid commercialization.

It is another object of the present invention to provide a system and method as aforesaid, wherein the electronic candles are provided and maintained at religious institutions.

It is another principal object of the present invention to provide automated collection and pilfer control for the aforesaid commercialization of electronic candles, particularly for religious institutions.

It is yet another object of the present invention to provide an improved electronic candle and system which is of practical design, readily installed and operated and yet safe and practical in use.

It is still yet another object of the present invention to provide a commercialized electronic candle lighting system, particularly for religious and/or memorial type purposes, which can be remotely paid for by any of cash or credit or debit cards or charged to accounts and activated and with optional provisions for remotely visually selecting a particular electronic candle or candles and for providing receipts for payments. Remote controlled generation of memorial designations are enabled for the printing or generation of personalized indicia which can be placed on selected lit electronic candles.

It is another object of the present information to provide the remotely activated memorial electronic candles at memorial sites, such as mausoleums, with remote visual viewing or confirmation of the lit electronic candles.

It is another object of the present invention to provide the electronic candle or candles with generated accounting data including gathering of the duration of lighting times of the individual or groups of candles and payments being made, with optional data with respect to which electronic candles and positions are more favorable for income generation.

The aforesaid objects are achieved by the present invention.

### SUMMARY OF THE INVENTION

This invention in one principal aspect is a system for the commercialization of electronic candle illuminations wherein payment is validated to actuate at least one candle of a plurality of candles. Once the candle is actuated for illumination, the user touches one candle to effect illumination for the prescribed time period. A chart or other visual means informs the user of the cost and committed illumination time period in order for the user to make an informed decision regarding payment. A currency validator or credit card payment validator senses the payment amount sends an electronic signal to a control unit or central unit wherein the illumination time is calculated, and in turn, an electronic signal is transmitted to the non-activated or lit candles to actuate the candles for the prescribed time corresponding to the payment. The user touches a desired selected candle which is, by such touching, illuminated for the prescribed period. With illumination of the one selected candle, the remaining unlit candles are de-actuated. The system is made for each present or subsequent user-purchaser to make accurate payment and effect illumination of the related electronic candle.

The system is multilevel pass code protected or can be induces encrypted or means for automatically providing encoded account statement of the candles illumination times and the corresponding payments represent those illuminations. The manufacturer of the electronic candles decrypts the account statement for confirming royalty or lease payments.

A stand is provided for mounting the candles in an arrangement. This arrangement provides the user with a diverse selection of positions from which to select the candle for illumination. The candles may also contain different indicia. This permits the user to select a candle that is most consistent with their devotional, memorial or emotional needs and desires.

In a preferred embodiment, the candle or array of candles is completely remotely accessible for payment and activation. In addition, the system may include a remote video view of the candle array in order to provide a visual selection of a desired (or non-previously lit candle) for specific selection of a candle to be lit. The visual video view also provides a real time confirmation of the actual lighting of the candle or candles. The remote view may be accessible at a specific location such as a neighborhood church or synagogue or it may be accessible on-line via an intra or internet hook-up and access.

The system optionally includes the capability of either remotely or locally printing or otherwise generating memorial or other indicia suitable for placement on a selected candle or candle as an indication of the actual memorialization for which the candle is being lit. This option is generally suitable for candles which are lit for relatively long term durations. See for example, the memorialization arrangements for internal or external insertion of a label as shown in U.S. Pat. No. 8,007,144.

In addition to the account statement generated for the purpose of royalty and leas payments, it is also preferred that the system includes a running compilation related to each candle or groups of candles. The compilation includes date, time and duration of the lighting of each of the candles individually and collectively, as well as a running compilation of generated income with related time and sources of the income. This data is used for estimating expected income and how to maximize income by controlling placement of candles and candle systems.

### BRIEF DESCRIPTION OF THE DRAWINGS

FIG. 1 is a block diagram showing the prior art method of electronic candle illumination at a religious institution.

FIG. 2 is a block diagram of the overall commercialization system of the present invention;

FIG. 3 is a detailed block diagram of the candle illumination system of the present invention;

FIG. 4 is a schematic depiction of a remote selection, payment and activation of candles with a video real time remote viewing of the candles for selection and confirmation of lighting; and

FIG. 5 is a schematic depiction of the generation of a sleeve for the electronic candle with memorial indicia thereon

### DESCRIPTION OF THE INVENTION

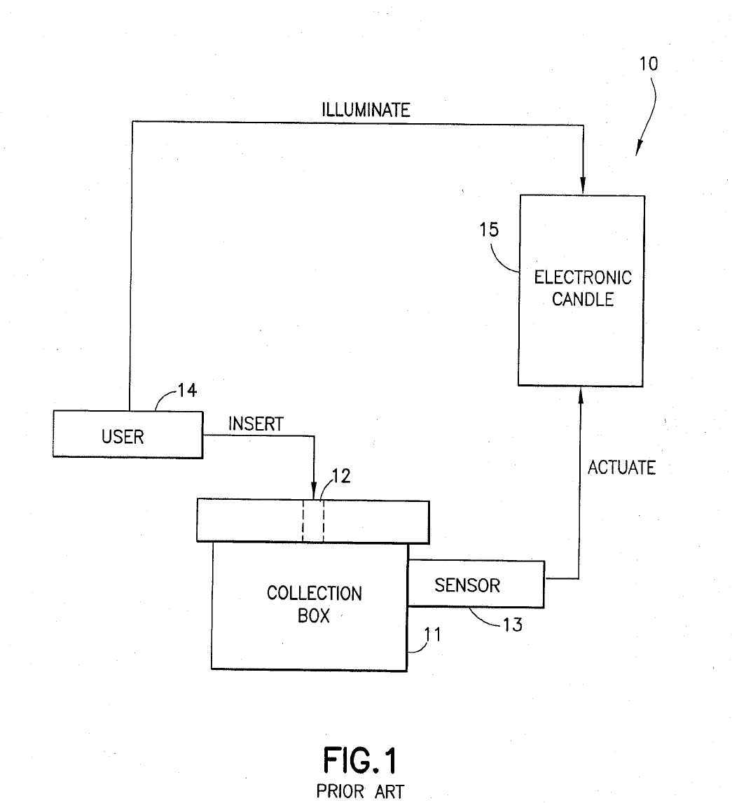

Referring to FIG. 1, there is shown a prior art electronic candle illumination system 10. System 10 is based on a collection box 11 having slot 12 of conventional construction. An object motion sensor 13 is mounted in the side of collection box 11. The user 14 inserts any object, e.g., coins, paper currency, token, paper, medals and the like, into slot 12. The sensor senses the object and in turn actuates at least one electronic candle 15 for illumination. The user then turns on the electronic candle 15 of their selection. This system did not provide a commercially viable system for candle illuminations, particularly for religious institutions and memorialization forums, e.g. cemeteries and memorials.

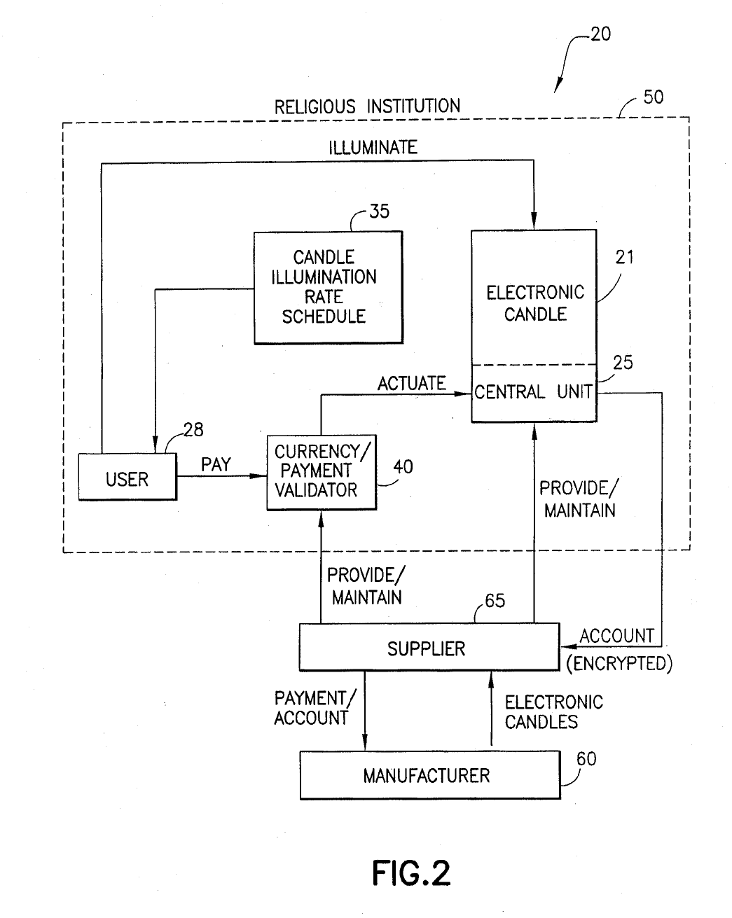

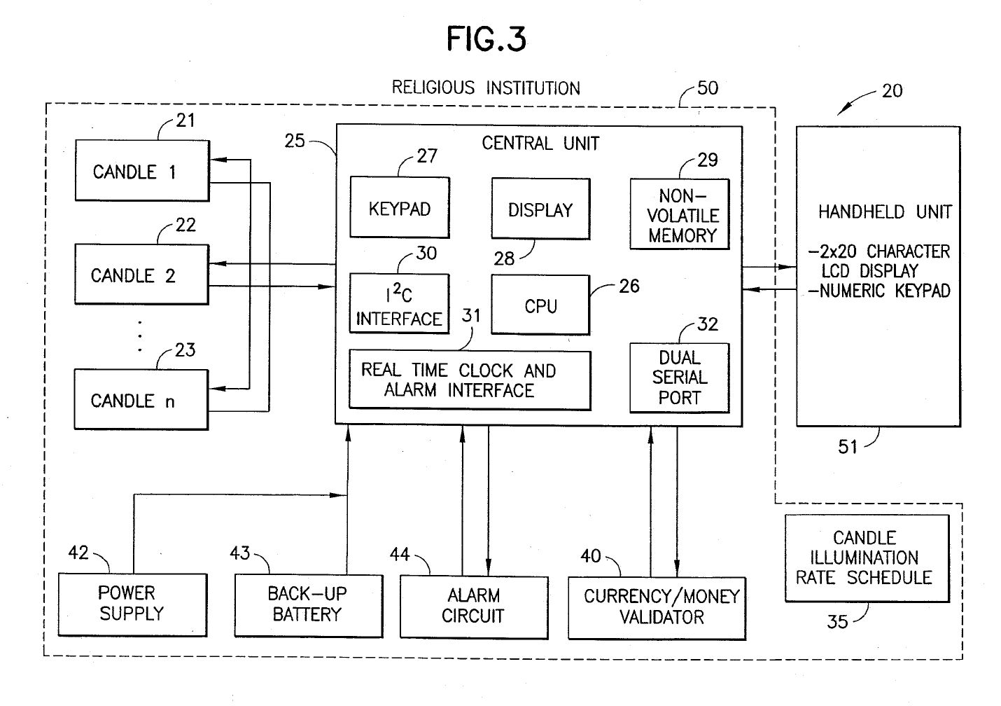

Referring to FIGS. 2 and 3, there is shown the system for the commercialization of electronic candies 20 of the present invention. System 20 includes a plurality of electronic candles, e.g. 21, 22 and 23. Electronic candles 21-23 imitate traditional wax candles, such as a votive or memorial candle, as will be further described hereinafter. A central unit or control unit 25 is another principal component of the system. Central unit 25 includes a CPU 26, keypad 27, display 28, non-volatile memory 29, I²C interface 30, real-time clock and alarm interface 31 and a dual serial port 32. The components 26-32 are assembled and programmed by means well know to one skilled in the control system art.

A currency/payment validator 40 is a further principal component of the present invention. Currency/payment validator 40 may be of conventional design and construction wherein a bill in any one of several denominations is inserted in a slot (not shown) in currency/payment validator 40. The inserted bill is acknowledged by an alpha-numeric display or illumination element (not shown). The inserted bill sends an electronic signal to central unit 25. A candle illumination rate schedule 35 advises the user 28 as to the illumination time for a prescribed payment. The electronic signal from currency/payment validator 40 to central unit 25 informs the central unit of the candle illumination period for which the prescribed payment was made. Central unit 25 in turn actuates candles 21-23 for that prescribed illumination period. The user 28 then touches a selected candle, e.g. 21 and in so doing, illuminates the selected electronic candle for the prescribed time period.

A power supply 42, back-up battery power source 43 and alarm circuit 44 complete the assembly provided to and maintained at religious institutions 50. A hand held unit (e.g., laptop computer) 51 may be plugged into central unit 25 for the purpose of recording the illumination times and/or payments mode. This account function may be encrypted, pass code protected or encoded by central unit 25. The manufacturer 50 may retain decryption means to read the encrypted account information. The encrypted account information is stored in the device or sent to designated location(s) or retrieved from the device by a hand held device (laptop computer) 51. A supplier 65 is under contract with the manufacturer to provide and manufacture the electronic candle 21-23, central unit 25 and currency/payment validator 40, as well as to take periodic account readings by means of hand held device 51, permit to a contractual arrangement with the manufacturer 50 and the religious institutions.

The present system 20 is provided on the aforesaid manner, which operation is desired is further discussed hereinafter.

One preferred electronic candle useful in the present invention is that shown and described in U.S. Pat. Nos. 6,017,139 and 8,007,144 granted Jan. 25, 2000, and Aug. 30, 2011 respectively to Gabor Lederer, the invention herein, which disclosure is incorporated in its entirety herein by reference thereto. This electronic candle includes a spring loaded switch and timer element, wherein the user merely touches or presses down on the candle housing to effect illumination for the prescribed time period. In the present invention, the electronic candle is only first actuated after the currency/payment validator 40 validates the actual and correct currency payment or donation. Touching or otherwise manipulating the selected illuminated electronic candle will not interfere with the continue illumination for the payment prescribed period of time.

### The Central Unit Operation

When currency/payment validator 40 senses a non-counterfeit bill and determines its face value, an electronic signal commensurate with the face value of the bill is sent to the central unit 25. The central unit calculates the prescribed illumination time for the currency value of that bill. The central unit then enters an electronic “ready to turn on” signal to every non-lit candle 21-23. The user then selects and turns on the selected electronic candle by pressing the top of the candle housing. This illumination of the candle will also send a recognition signal to the central unit 25. The recognition signal identifies the illuminated candle and the first of the illumination, as well as the illumination time. This information is stored in the central unit memory. The central unit then sends a “not ready” or “disabled” signal to the other non-lit candles. None of the other candles can be turned on until a new “ready to turn on” signal is generated. The central unit 25 tracks the illumination history of every candle. After the prescribed illumination time has elapsed, the central unit 25 sends a “turn off” signal to the afore-discussed illuminated candle. In order to insure user recovery in the event of power failure, every illumination start time and illumination lapse period is stored in the instrument, and updated in a non-volatile memory 29 every couple of milliseconds.

### The CPU and Currency Validator Interface

The currency/payment validator 40 can recognize different bills. Validation is set for the customary are the $1, $5, $10 and $20 bills. The currency/payment validator 40, however, may be set for any currency including foreign currency in diverse face values. The operator or religious institutions are able to dedicate any time interval to any bill value and store them in the memory of the CPU through push-buttons and LEDs displays (on the front panel of the unit). It also can be changed remotely via web connection.

It is understood that the above example and drawings are merely exemplary of the present invention and that changes in the method, system and apparatus and afore-discussed may be made without departing from the scope of the present invention as defined in the following claims.

### Collection Accounting and Pilfer Control

it is an unfortunate fact of present reality that church collection boxes are pilfered. The electronic candle art desires a commercialization system with automated collection accounting and pilfer control.

In the present invention, the central unit 25 monitors money collection values opening and closing dates and amounts of the collection box. It also register trough the pass code protection the person's name who opened the box. This information is encrypted in the unit and can be remotely provided to the religious institution, the supplier and/or the manufacturer by electronic transmission means well known in the art. Non-wireless communication is also within the contemplation of the present invention. This collection box accounts information may also be encoded by the central processing units. A decryption means may be provided to the religious institution, supplier and/or manufacturer, whereby the electronically determined accounts and the physically accumulated monies are reconciled. In the event that any one collection does not correlate with the electronic accounts, the religious institution is able to identify the specific collector responsible for the deficient collection. The electronic accounts also permits a ready determination regarding distribution of the collected monies among the religious institutions, suppliers and manufacturer.

The automated system also contemplates providing an accounting for a pre-selected period of time, e.g. a month or a year, coins with the terms of commercialization between the manufacturer and the religious institution. As described above, the automated system further provides detailed data for the specific candles or groups of candles, of specific lighting times, duration and expected. Income to be generated to provide a planning basis for the installation of the candle systems at various location.

Remote Candle Selection, Payment and Action with Remote Viewing

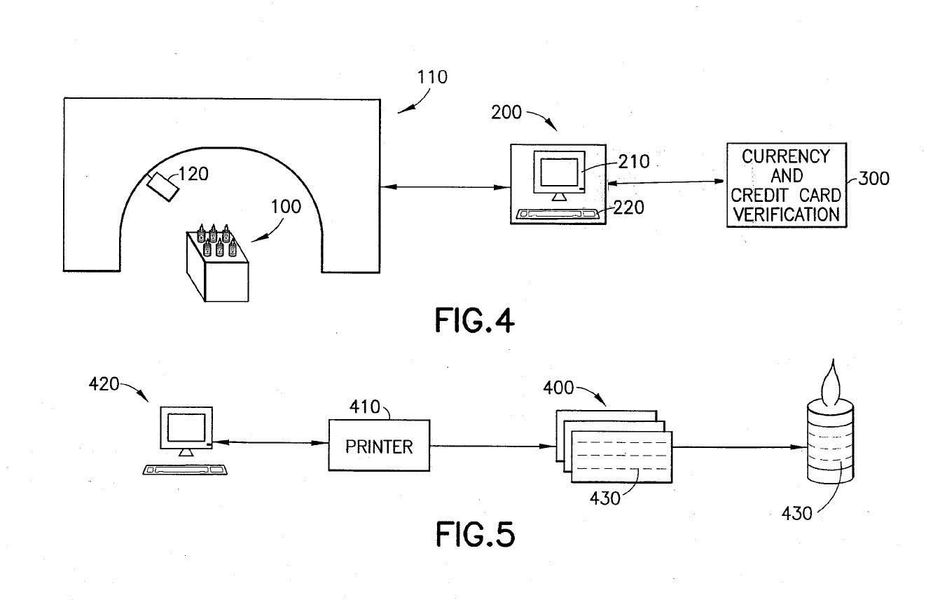

As seen in FIG. 4, an electronic candle array 100 is positioned in an area of a mausoleum 110 visible by visitors. The candle array 100 is electronically connected for remote payment and activation whereby a person at a remote location 200 can view the array on a screen 210 via camera 120 in real time. The person is then directed to pay a selected fee for activation of one or more candles for a specific period of time. Payment is made remotely by credit or account information via entry keyboard 220 or, if at an established remote location, via the currency and credit card verification system 300, as described above, located at such remote location.

Verification of the candle lighting is then made remotely via the same camera 120 by which selection was initially made.

FIG. 5 depicts the optional, whether remotely, via computer link and control 420 or locally, generation of a sleeve 400, such as with printer 410 for a selected candle with memorial or similar indicia 430 thereon (payment is similarly made for such optional service). The printed sleeve 400 is then locally manually placed by an attendant (whether generated remotely or locally) on the selected lit candle as a display showing the person or reason the candle is lit. With extinguishing of the candle, an attendant removes the sleeve(s) for either storage or disposal

It is also within the contemplation of the present invention for the manufacturer to provide the services and activities of the supplier.

It is also within the contemplation of the present invention for the religious institution to purchase the electronic candles from the manufacturer and have the manufacturer service the electronic candles and the automated controls and accounting.

What is claimed is:

1. A system for the commercialization of electronic candle illuminations, comprising:
a plurality of electronic candles, each candle comprises a computer controlled element configured for locally or remotely selectively illuminating the candle, and further comprises a disabling element configured for disabling remaining non-selected candles with illumination of the selected candle, and elements configured for validating and accepting a debit or credit card payment from a user desirous of illuminating the one selected candle, and a connection element configured for electronically connecting the elements for validating and accepting the payment to the plurality of electronic candles, wherein, with validation and acceptance of the selected payment amount the one candle only is actuated for a predetermined time of illumination, with the predetermined time of illumination being commensurate in duration with a predetermined value of the payment being accepted.

2. The system of claim 1, further comprising an element configured for automatically discontinuing illumination of the selected illuminated candle after the pre-determined time.

3. The system of claim 1, wherein each electronic candle illumination element includes at least one comprises LED.

4. The system of claim 3, wherein the electronic candles are not powered for actuation prior to validation and acceptance of payment.

5. The system of claim 4, wherein the element for selectively illuminating the candle comprises an element configured for effecting illumination of the selected candle with a touching of the selected candle by the user.

6. The system of claim 1, wherein with remote selection, the system further comprises a video viewing element configured to provide a selector of an electronic candle to be illuminated with a remote real-time view of the electronic candles prior to illumination for selecting of non lit candles for illumination and a remote real-time view of the candles after illumination, as verification of the illumination

7. A system for the commercialization of electronic candle illuminations, comprising:
a plurality of electronic candles, with each candle comprising an element configured for selectively illuminating the candle, and the system further comprises an element configured for disabling non-selected candles with illumination of the selected candle, and an element configured for validating and accepting a paper currency payment of an amount up to the value of the paper currency from a user desirous of illuminating the one selected candle, the system further comprising an element configured for electronically connecting the element for validating and accepting the payment to the plurality of electronic candles, and with validation and acceptance of the payment amount the one selected candle is configured to be actuated for a predetermined time of illumination, wherein the predetermined time of illumination is commensurate with the accepted value of the payment.

8. The system of claim 7, wherein each electronic candle illumination element includes at least one LED.

9. The system of claim 7. wherein the selected electronic candle is not powered for actuation prior to validation of payment.

10. The system of claim 9, wherein the element configured for selectively illuminating the candle further comprises an element configured for effecting illumination of the selected candle with a touching of the selected candle by the user.

11. The system of claim 10, further comprising an element configured for automatically discontinuing illumination of the selected illuminated candle after the pre-determined time.

12. The system of claim 7, said plurality of candles being disposed at a first location, and an element configured for accounting of the validated payment being remotely disposed at a second location.

13. The system of claim 12, wherein said element for accounting for the validated payment of the selected electronic candle comprises a keypad.

14. The system of claim 7, wherein said element for selectively illuminating the candle is operably associated with the selected candle and is responsive to a touching by a user after validation of the payment.
